(19) United States
(12) Patent Application Publication
(10) Pub. No.: US 2010/0129515 A1
(43) Pub. Date: May 27, 2010

(54) FLAVOUR MODULATING SUBSTANCES

(75) Inventors: Chris Winkel, Bussum (NL); Abdelmajid Kaouas, Utrecht (NL); Sylvia N. Noomen, Gouda (NL); Harry Renes, Lelystad (NL)

Correspondence Address: YOUNG & THOMPSON, 209 Madison Street, Suite 500, Alexandria, VA, 22314, US

(73) Assignee: QUEST INTERNATIONAL SERVICES B.V., NAARDEN (NL)

(21) Appl. No.: 11/995,336

(22) PCT Filed: Jul. 28, 2006
(86) PCT No.: PCT/NL06/50190

§ 371 Date: Jan. 11, 2008

(30) Foreign Application Priority Data
Jul. 29, 2005 (EP) 05107039.9
May 8, 2006 (EP) 06113633.9

(51) Int. Cl. A23L 1/22; A23L 2/56

(52) U.S. Cl. 426/534

(57) ABSTRACT

The present invention in a first aspect relates to flavour modulation in foodstuffs, beverages, tobacco products and oral care products, using a flavour modulating substance selected from the group represented by formula (I), edible salts thereof and edible esters thereof. It has been found that these substances are capable imparting highly desirable taste attributes in the products they are incorporated in. In addition said flavour modulating substances are capable of modulating and complementing, the sensory impact of other, taste imparting, substances. Thus, the present substances are advantageously applied in flavour compositions, foodstuffs, tobacco products and oral care products. Typical examples of flavour modulating substances according to the present invention include N-vanillyl urea, N-vanillyl thiourea, N-vanillyl guanidine, N-isovanillyl urea, N-(3-ethoxy-4-hydroxybenzyl) urea, N-(3,4 dimethoxybenzyl) urea, N,N′-divanillyl urea, N,N′-divanillyl thiourea, N-octyl-N′-vanillyl urea, N-octyl-N′-vanillyl thiourea, N-hexyl-N′-vanillyl urea, N-hexyl-N′-vanillyl thiourea, N-decyl-N′-vanillyl urea, N-decyl-N′-vanillyl thiourea, N-benzyl-N′-vanillyl urea, N-benzyl-N′-vanillyl thiourea, edible salts thereof and edible esters thereof.

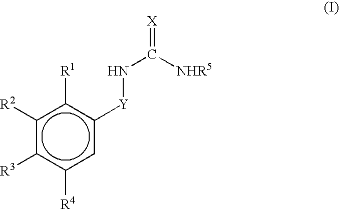

### FIELD OF THE INVENTION

The present invention relates to the field of improving the flavour of foodstuffs, beverages, tobacco products and oral care products. More particularly, the present invention provides flavour modulating substances and compositions comprising them that can be used to improve and complement the impact of other flavour imparting substances. The present invention also encompasses the use of the aforementioned flavour modulating substances as well as foodstuffs, beverages, tobacco products and oral care products containing these substances.

### BACKGROUND OF THE INVENTION

The flavour of foodstuffs and beverages consists of two parts: the aroma and the taste. In general what is perceived through the olfactory epithelium in the nasal cavity is referred to as ‘aroma’, whereas the term ‘taste’ is generally used to describe the sensory impact that is perceived via the mouth, especially the tongue. The flavour sensation experienced upon consumption, especially taste, provides the final analysis of food prior to ingestion thereof. Visual and olfactory (smell) signals already give a first indication but only after intake of the food into the mouth the final decision is made either to ingest or to reject the food. Sweet taste is usually a signal that the food is safe (appetising) leading to ingestion of the food. The ‘reactions’ to salt and umami are really dependent on the strength of the signal. Bitter and sour are usually repulsive taste sensations, leading to rejection. Temperature is another measure by which the food is judged just as well as aching sensations like capsaicin (hot pepper) and certain chemicals (like carbon dioxide).

In short, this means that taste is a very important and very complex system. Until recently most flavour research was focused towards aroma. Especially the last years a series of publications relating to molecules with a (positive) contribution to the taste of foodstuffs has emerged.

Such research has been stimulated significantly by the fact that quite some receptors which are involved in the different taste sensations have been characterized by now (B. Lindemann; Nature 413, 219 (2001)).

Another interesting aspect of taste is that it can have an impact on aroma. It was reported that people having artificially sweetened water in their mouth were significantly more sensitive to the smell of benzaldehyde than people having plain water in their mouth (P. Dalton et al, Nature Neurosci. 3, 431-432 (2000)).

Several screening systems have been described that make it possible to screen, in a short time, large series of molecules for their (modulating) effect on taste response (cf. WO 04/055048, GB 2396414, WO 01/77292 and US 2004/0072254).

Most research on taste modulation so far has been devoted to taste enhancement in savoury products. Several, mainly Japanese, publications describe umami molecules, i.e. alternatives to mono sodium glutamate (MSG) (H Suzuki et al, J Agric Food Chem 50, 313-318 (2002); K Shima et al, J Agric Food Chem 46, 1465-1468 (1998); Y Ueda et al, Biosc Biotech Biochem 61, 1977 (1997)).

In EP 1291342, a ‘general taste enhancer’ is disclosed that was reported to be suitable for enhancing sweetness as well.

In patent applications WO 97/04667 and WO 04/075633 tripeptides and amino acid condensates with lactic acid and succinic acid are described that have both their own taste as well as some enhancing properties. Alpha keto acids are reported to give body and mouthfeel to foodstuffs they are added to (U.S. Pat. No. 6,287,620).

Chlorogenic acids are claimed to enhance sweetness and to reduce bitterness (WO 02/100192).

Quite a bit of work has been devoted to find bitter taste suppressors (A. N. Pronin et al, Chemical Senses 29, 583-593 (2004); EP 1401500; P. A. Breslin, Trends in Food Science & Technology 7, 390-399 (1996)).

In sweet and beverage products, further examples of the importance of the gustative dimension of flavourings have been reported. These examples include taste attributes such as bitterness, tingling and cooling-freshness.

Bitterness is an essential aspect of some food flavours, among which chocolate taste. Purine alkaloids, like theobromine and caffeine, as well as amino acids and peptides have been known for a long time as bitter substances. In British patent no. GB 1420909 it is disclosed that the bitter flavour of cocoa can be reproduced using a combination of a purine alkaloid and an amino acid or an oligopeptide which ‘produces a surprisingly more natural simultaneously bitter and astringent flavour note than either of these types of substances alone’.

Menthol, an important constituent of peppermint oil, has a strong impact on flavoured products not only because of its mint smell but also because it imparts a cooling and fresh taste. Next to mint flavoured products, it has been suggested to employ menthol in other types of flavour to impart a cool taste. US patent application no. US 2005/013846 for example discloses how menthol and derivatives thereof can be used as flavouring in water continuous spreadable acidified food products to obtain table spreads exhibiting a fresh, cool taste impression.

Similarly, cinnamic aldehyde and eugenol, constituents of cinnamon oil, are used in flavouring composition for confectionery products, not only for their smell but also because they impart a warm and tingling taste. The oral pungency of cinnamic aldehyde was described as burning and tingling by Cliff M and Heymann H (Journal of Sensory Studies 7, 279-290 (1992)). According to the same authors eugenol exhibits a long-lasting numbing effect. Cinnamon oil has been proposed as a taste improving flavouring. International patent application no. WO 90/06689 discloses that cinnamon oil, among other spice extracts, added to a minty flavour formulation, can be used to improve the long-lasting flavour of chewing-gum.

Alcohol is perceived by its typical smell but also by the irritating sensation in the nose and mouth and by its pungent taste. The pungency of ethanol is diffuse, with some burning and tingling sensations, predominantly in the front of the tongue. It has short onset and duration. Some flavours have been described to mimic the ethanol sensation and can thus be useful in alcoholic beverages and foodstuffs. Menthol and capsaicin are claimed to provide a burning sensation similar but not identical to alcohol.

U.S. Pat. Nos. 6,476,252 and 6,203,839 disclose flavouring compositions containing 1′-acetoxychavicol acetate, 1′-acetoxyeugenol acetate and related compounds having a warming, alcohol-boosting effect in alcoholic beverages. According to said documents these substances can make a beverage containing about 15% alcohol taste like one containing about 30% alcohol.

Vanillyl alcohol derivatives (e.g. vanillyl methyl or ethyl ether) are disclosed in patent US 2002/0013235 as having a strong pungent taste and warm feeling imparting effect. The same substances are described in patent JP 57082308 to be effective in increasing the refresh-feeling imparting effect of menthol. Vanillyl ethyl ether is more specifically disclosed as taste improving agent for beer in patent JP 20044229562. Substances from the same group such as vanillyl n-propyl ether are also disclosed in patent JP 57009729 as useful ingredients for salty taste.

Six different carbamic amides of vanillylamine, being structurally analogues to the pungent principle of cayenne pepper, have been tested for their properties of pungency (Lange et al.; J. Am. Chem. Soc., vol. 51, no. 6, 1911-1914 (1929). Vanillylurea, vanillylthiourea and phenylvanillylthiourea were however reported to be tasteless both as a dry powder and as an alcoholic or aqueous solution. Phenylvanillylthiourea, p-tolylvanillyithiourea and o-tolylvanillylthiourea were found to have the property of pungency but to a lesser degree than capsaicin.

Vanillyl amine and vanillyl acyl amids are also reported (U.S. Pat. No. 1,329,272) to be pungent molecules and can be used as substitutes or to fortify cayenne pepper for use in food and beverage to produce a hot or pungent taste.

N-(3-Acyloxy-2-benzylpropyl)-N-(4-hydroxy-3-methoxybenzyl) thiourea derivatives are disclosed as potent vanilloid receptor agonists and analgesics (Lee et al.; Bioorganic and medicinal chemistry 9, 9-12 (2001)). According to WO 2005/006881 these thiourea derivatives are also ligands of TRP V1 receptor, such that they would exhibit salty taste characteristics.

There is still a need for new substances having a positive contribution to the flavour, especially taste, of foodstuffs, beverages, tobacco products and/or oral care products they are incorporated in. One objective of the present invention is the provision of new substances and compositions that can complement and improve the impact of other flavour imparting substances, in particularly substances that can mimic and boost the ethanol sensation in foodstuffs and beverages.

### SUMMARY OF THE INVENTION

The present inventors have surprisingly found that substances selected from the group represented by formula (I):

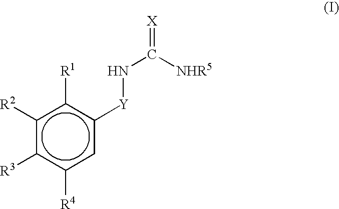

and edible salts thereof and edible esters thereof can advantageously be used for modulating the flavour of foodstuffs, beverages, tobacco products and oral care products.

The present flavour modulating substances can be used to impart desirable taste attributes in a wide variety of applications and products. In addition, the present flavour modulating substances are capable of modulating the taste and/or aroma impact of other, flavour imparting, substances contained within these same products, thereby improving the overall flavour quality of these products. The present flavour modulating substances were found to be particularly suitable for mimicking and/or boosting ethanol sensation, cooling effects and/or salt taste impact.

Therefore, the present invention relates to these flavour modulating substances and to compositions comprising one or more of these substances. Furthermore, methods of improving the flavour of a product selected from foodstuffs, beverages, tobacco products and oral care products, especially alcoholic foodstuffs and beverages, as well as products comprising the present taste improving substances are provided by the invention

### DETAILED DESCRIPTION OF THE INVENTION

Thus, a first aspect of the present invention relates to the use for improving the flavour, especially the taste of foodstuffs, beverages, tobacco products and/or oral care products, of a flavour modulating substances selected from the group represented by formula (I), edible salts thereof and edible esters thereof:

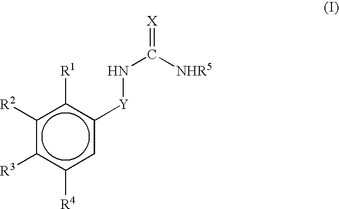

wherein
R¹, R², R³ and R⁴ independently represent hydrogen, hydroxyl or a C₁-C₃ alkoxy group,
R⁵ represents hydrogen, phenyl, linear C₁-C₁₂ alkyl or C₇-C₁₂ aralkyl, each optionally substituted with one or more substituents selected from C₁-C₆ alkyl, and hydroxyl; or a moiety represented by the following formula (II):

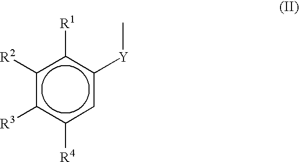

Y represents —CH₂— or —C(O)—; and
X represents ═NH, ═O or ═S; with the proviso that at least one of R¹, R², R³ and R⁴ represents hydrogen; and to compositions comprising at least 0.001 ppm, preferably at least 0.01 ppm, still more preferably at least 0.1 ppm of one or more of the present flavour modulating substances.

The present inventors have found that the above-mentioned flavour modulating substances are very useful flavour ingredients which, particularly in the presence of other flavour imparting substances, are capable of imparting highly appreciated taste sensations to the products in which they are incorporated, specifically “cooling”, “pungent”, “sharp”, “hot” “tingling”, “bite”, “burning”, “warm”, “alcohol-like”, “continuity”, “complexity”, “expanding”, “salty”, “umami” and/or “long lasting”. Because of this, the present substances can be employed to improve the flavour, especially taste (including “mouthfeel”), of foodstuffs, beverages, tobacco product and oral care products.

The flavour modulating substances of the present invention as such are capable of imparting highly desirable taste attributes. In addition, it has been found that the flavour modulating substances according to the invention are capable of complementing and modifying the sensory impact of other, flavour imparting, substances, contained in the aforementioned products, including complementing and modulating “alcohol sensation”, “bitterness”, “hot taste sensation”, “cold taste sensation”, “carbonation effects”, and/or “salt taste impact”.

Throughout this document the term “flavour” is used to describe the sensory impact that is perceived via the mouth, especially the tongue, and the olfactory epithelium in the nasal cavity. The term “complementing and modifying the sensory impact” as used herein refers to the capability of the present compositions or substances to alter the taste and/or aroma impact of other, flavour imparting, substances present within the same product, with the proviso that this change in taste impact is not caused by the flavour contribution of said composition or substance per se, but instead that it mainly results from the combined effect of on the one hand the present flavour modulating composition or substance and on the other hand the other flavour imparting substance(s). The present flavour modulating substances combine the capability of modulating the taste and/or aroma of other, flavour imparting, substances and a taste contribution of their own. The favourable impact of the present flavour modulating substances is believed to be the result of the combination of these two effects.

Because the flavour modulating substances according to the invention are not particularly volatile, they do not produce a strong aroma impact, even though they can affect the aroma impact of other flavour imparting substances. Here the term “aroma” refers to the aspect of flavour that is perceived through the olfactory epithelium. Because of the low volatility of the present flavour modulating substances it is believed that the advantageous properties of these substances are somehow associated with the impact that these substances have on the sensory receptors located within the mouth.

It was found that particularly satisfying results can be obtained with flavour modulating substances as defined herein before wherein at least two of R¹, R², R³ and R⁴ represent hydrogen. In a preferred embodiment, R¹ and R² independently represent hydroxyl or a C₁-C₃ alkoxy group, preferably methoxy or ethoxy. Most preferably one of R¹ and R² represents methoxy or ethoxy, preferably methoxy, and the other one represents hydroxyl.

Even more preferably R² and R³ independently represent hydroxyl or a C₁-C₃ alkoxy group, preferably methoxy or ethoxy. Still more preferably one of R² and R³ represents methoxy or ethoxy, preferably methoxy, and the other one represents hydroxyl. Most preferably R² represents methoxy and R³ represents hydroxyl.

According to one embodiment the flavour modulating substance represented by formula (I) is preferably a vanillyl derivative, an isovanillyl derivative, a 3,4-dimethoxybenzyl derivative, an ethylvanillyl derivative (i.e. a 3-ethoxy-4-hydroxybenzyl derivative), a galloyl derivative, a syringoyl derivative (i.e. a 3,5-dimethoxy-4-hydroxybenzyl derivative), a parahydroxybenzyl derivative, a protocatechoyl derivative, an α-resorcoyl derivative or a salicoyl derivative, more preferably a vanillyl derivative, an isovanillyl derivative, a 3-ethoxy-4-hydroxybenzyl derivative, a 3,4-dimethoxybenzyl derivative, a parahydroxybenzyl derivative or a protocatechoyl derivative, most preferably a vanillyl derivative.

According to another preferred embodiment of the invention, Y represents —CH₂—. According to this embodiment the present flavour modulating substance is typically a derivative of a substituted benzyl amine.

According to another preferred embodiment Y represents —C(O)—. According to this embodiment, the present flavour modulating substance is typically a derivative of a substituted benzoic acid.

According to still another, equally preferred, embodiment R⁵ represents hydrogen, 2-hydroxyethyl or a moiety represented by formula (II), more preferably R⁵ represents hydrogen or a moiety represented by formula (II), most preferably R⁵ represents hydrogen.

According to still another equally preferred embodiment R⁵ represents linear C₃-C₁₂ alkyl, optionally substituted with one or more C₁-C₆ alkyl groups, more preferably with one or more C₁-C₄ alkyl groups. More preferably R⁵ represents linear C₄-C₁₀ alkyl, optionally substituted as described above. Even more preferably, R⁵ represents butyl, pentyl, hexyl, heptyl, octyl, nonyl or decyl; still more preferably octyl.

In yet another equally preferred embodiment, R⁵ represents phenyl or C₇-C₁₀ aralkyl, optionally substituted with one or more C₁-C₆ alkyl groups, more preferably with one or more C₁-C₄ alkyl groups. More preferably R⁵ represents phenyl or C₆-C₁₀ aralkyl, most preferably R⁵ represents phenyl, benzyl or phenethyl.

In still another, equally preferred, embodiment X in formula (I) represents ═O or ═S, most preferably ═O. Accordingly, the flavour modulating substances of the present invention are preferably derivatives of urea, thiourea and/or guanidine and edible salts of said derivatives, more preferably derivatives of urea and/or thiourea, most preferably urea, and edible salts of said derivatives.

Thus, the present flavour modulating substance is preferably selected from the group of N-vanillyl urea, N-vanillyl thiourea, N-vanillyl guanidine, N-isovanillyl urea, N-(3-ethoxy-4-hydroxybenzyl) urea, N-(3,4 dimethoxybenzyl) urea, N,N′-divanillyl urea, N,N′-divanillyl thiourea, N-octyl-N′-vanillyl urea, N-octyl-N′-vanillyl thiourea, N-hexyl-N′-vanillyl urea, N-hexyl-N′-vanillyl thiourea, N-decyl-N′-vanillyl urea, N-decyl-N′-vanillyl thiourea, N-benzyl-N′-vanillyl urea, N-benzyl-N′-vanillyl thiourea edible salts thereof and edible esters thereof.

Still more preferably the present taste improving substance is selected from the group of N-vanillyl urea, N-vanillyl thiourea, N-(3-ethoxy-4-hydroxybenzyl) urea, N-octyl-N′-vanillyl urea, N-octyl-N′-vanillyl thiourea, edible salts thereof and edible esters thereof.

Most preferably the present flavour modulating substance is selected from N-vanillyl urea or N-vanillyl-N′-octyl urea, edible salts thereof and edible esters thereof.

As used herein the term ‘edible esters thereof’ encompasses any edible derivative of the present flavour modulating substances and an acid. Typically said acid is an organic acid such as a substituted or non-substituted, linear or branched C₁-C₆ carboxylic acid, more preferably a C₁-C₄ carboxylic acid, most preferably a C₁-C₃ carboxylic acid, or alternatively an inorganic acid such as phosphoric acid. Such esters can be formed in case the flavour modulating substance comprises a hydroxyl substituent and will, at least to a certain degree, possess some of the flavour characteristics of the corresponding substance according to formula (I) that is not esterified.

According to a preferred embodiment the present flavour modulating substance is selected from the group of substances represented by formula (I) as defined herein before and salts thereof.

In a second aspect of the present invention a flavour compositions are provided comprising, based on the total (dry) weight of the composition, at least 0.1 wt %, more preferably at least 0.5 wt %, most preferably at least 1 wt %, of one or more flavouring substances and at least 0.001 wt. %, preferably at least 0.01 wt. %, of one or more of the present flavour modulating substances as defined herein before. Most preferably, the flavour composition contains at least 0.1 wt % of the present flavour modulating substances. Preferably the amount of the present flavour modulating substances does not exceed 80 wt %, more preferably it does not exceed 40 wt %. As used herein, the term “flavouring substance”, refers to any substance that is not represented by formula (I) and that is capable of imparting a detectable flavour impact, especially at a concentration below 0.1 wt. %, more preferably below 0.01 wt. %. Typically, the present flavouring substances belong to one or more of the chemical classes of alcohols, aldehydes, ketones, esters, ethers, acetates, nitriles, terpene hydrocarbons, nitrogenous or sulphurous heterocyclic compounds and essential oils, and said flavouring substances can be of natural or synthetic origin. Many of these are listed in reference texts such as the book by S. Arctander (Perfume and Flavor Chemicals, 1969, Montclair, N.J., USA), or its more recent versions, or in other works of a similar nature, as well as in the abundant patent literature in the field of flavours.

Typically, in the present flavour composition, the one or more flavour modulating substances and the one or more flavouring substances as defined herein before are employed in a weight ratio within the range of 10:1 to 1:100, preferably in a weight ratio of 5:1 to 1:50.

The flavour composition according to the present invention may suitably be prepared in the form of a liquid, a paste or a powder. Flavour compositions according to the present invention preferably comprise at least one edible/food grade carrier, examples of which include maltodextrin, modified starch, gum arabic, propylene glycol and ethanol. In a particularly preferred embodiment the flavour composition is a free flowing powder.

Preferred examples of flavour compositions according to the present invention include sweet flavouring compositions, comprising one or more of the present flavour modulating substances and at least one flavouring substance that is typically used in sweet flavour applications, more particularly in the field of dairy, beverage and/or confectionery, still more preferably a flavouring substance that is commonly used in the field of flavouring alcoholic beverages, carbonated and still beverages.

In another preferred embodiment the present composition is a product selected from foodstuffs, beverages, tobacco products and oral care products, said product comprising at least 0.01 ppm, more preferably at least 0.1 ppm, still more preferably at least 0.25 ppm, most preferably at least 1 ppm of the present flavour modulating substances as defined herein before. Typically, the aforementioned products will contain the flavour modulating substances in a concentration of not more than 1000 ppm, preferably of not more than 500 ppm, most preferably of not more than 100 ppm. The present product will furthermore comprise one or more flavouring substances as defined herein before and/or other flavour imparting substances.

Typical examples of said products include alcoholic beverages, carbonated beverages, still beverages, yoghurts, ice creams, desserts, confectioneries, sweet snacks, seasonings, sauces, stocks, soups and dressings. The benefits of the present invention may also be realised in oral care products such as toothpaste and mouthwash and in tobacco products, which includes any type of tobacco product for smoking as well as for non-smoking applications. It is noted that tobacco-like products are available for both smoking and non-smoking applications. The use of the present taste improving substances in these tobacco substitutes is also encompassed by the present invention.

Preferably the present product is selected from the group of alcoholic beverages, carbonated beverages, still beverages, yoghurts, ice creams, desserts, confectionery products, mouthwashes and toothpastes.

According to another particularly preferred embodiment the foodstuff or beverage is an alcoholic foodstuff or an alcoholic beverage. As used herein, the term ‘alcoholic foodstuff or alcoholic beverage’ refers to foodstuffs or beverages comprising ethanol, preferably in an amount of at least 0.5 wt %. More preferably said foodstuff or beverage comprises less than 50 wt %, still more preferably 40 wt % of ethanol, still more preferably it comprises 2-30 wt %, most preferably 2-20 wt % of ethanol. Thus foodstuffs and beverages are provided by the present invention comprising at least 0.5 wt % of ethanol and at least 0.01 ppm of a flavour modulating substance as defined herein before.

Another aspect the present invention relates to a process of improving the flavour of a product selected from foodstuffs, beverages, tobacco products and oral care products, said process comprising incorporating into said product one or more flavour modulating substances as defined herein before, in an amount of at least 0.01 ppm, preferably of at least 0.1 ppm, most preferably at least 1 ppm. Preferably said amount does not exceed 1000 ppm, more preferably it does not exceed 500 ppm, still more preferably it does not exceed 100 ppm. As mentioned herein before, a preferred embodiment relates to a process wherein the product is a foodstuff or beverage comprising at least 0.5 wt % of ethanol.

Still another aspect of the invention relates to the use of the flavour modulating substances as defined herein before for improving the flavour of a product selected from foodstuffs, beverages, tobacco products and oral care products. A preferred embodiment relates to the use of the present flavour modulating substances, as defined herein before, for mimicking and/or boosting ethanol sensation in foodstuffs or beverages, preferably, as mentioned herein before, in foodstuffs or beverages, comprising at least 0.5 wt % of ethanol. According to a preferred embodiment the present invention encompasses the use of the present flavour modulating substances, as defined herein, in an amount of between, 0.01-1000 ppm, more preferably 0.1-500 ppm.

Another embodiment of the invention relates to the use of the flavour modulating substances as defined herein before for imparting and/or modulating hot and/or cold taste sensation in the aforementioned products.

Yet another aspect of the present invention relates to processes of preparing flavour modulating substances, preferably flavour modulating substances as defined herein before.

According to one embodiment, said process comprises reacting a substance represented by the following formula (III) or a salt or ester thereof with a substance represented by the following formula (IV) or a salt thereof:

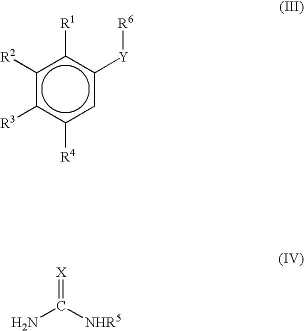

wherein R¹, R², R³, R⁴, R⁵, X and Y have the same meaning as defined herein before and wherein R⁶ represents —NH₂ if Y represents —CH₂—, or R⁶ represents —OH or —H if Y represents —C(O)—.

Preferably said reaction is performed by heating to reflux said reactants in an organic solvent, such as toluene or pyridine, for a period of between 0.1-10 hours. According to a preferred embodiment, the reactants are used in a molar ratio of between 1:1 and 1:10. The larger, the excess of said compound represented by formula (I) and/or the longer the heating is continued, the more of a flavouring modulating substance wherein R⁵ represents a moiety according to formula (II) as defined herein before will be obtained. Flavour modulating substances represented by formula (I) wherein R⁵ is 2-hydroxyethyl can be prepared by heating to reflux a substance according to formula (I) wherein R⁵ represents hydrogen, obtainable by the present process, and ethanolamine in an organic solvent.

According to the present processes the reaction products are typically obtained as a precipitate and can be isolated by evaporating the solvent and optionally further purified using any of the techniques known by the skilled person, such as chromatography and crystallization.

In another embodiment of the invention, flavour modulating substances represented by formula (I) as defined herein before, wherein X represents ═O or ═S, are prepared by reacting in an organic solvent, a substance represented by the aforementioned formula (III) or a salt or ester thereof, wherein R⁶ represents —NH₂, with a cyanate or a thiocyanate, such as potassium cyanate, potassium thiocyanate, sodium cyanate or sodium thiocyanate or derivatives of such cyanates or thiocyanates such as N-alkyl-isocyanates or N-alkyl-isothiocyanates. The reaction product is typically obtained as a precipitate and can be isolated by evaporating the solvent and optionally further purified.

In still another embodiment of the invention, flavour modulating substances represented by formula (I) as defined herein before, are prepared by reacting in an organic solvent, an 1H-imidazole-1-carboxamide; a derivative thereof, such as an N-alkyl-1H-imidazole carboxamide; an 1H-imidazole-carbothioic acid amide or a derivative thereof, such as an N-alkyl-1H-imidazole-carbothioic acid amide, with a substance represented by the aforementioned formula (III) or a salt or ester thereof, wherein R⁶ represents —NH₂. The reaction product is typically obtained as a precipitate and can be isolated by evaporating the solvent and optionally further purified.

Another aspect of the present invention relates to flavour modulating substances and compositions obtainable by any of the aforementioned processes. The invention is further illustrated by means of the following examples

### EXAMPLES

### Example 1

N-vanillyl urea was prepared by mixing 2 g of vanillin amine hydrochloride and 2 g of urea in 25 ml of toluene and refluxing for 6 hours. A precipitate was formed in the solvent. The precipitate was isolated by filtration, grinded and subsequently washed with ethyl acetate and, successively, with a small amount of water and then dried under vacuum at 50° C. The product was analyzed with NMR and shown to be N-vanillyl urea with a purity >90%. The yield of the reaction was calculated to be 80%.

### Example 2

The solid product obtained in example 1 was dissolved in ethanol/water (1:1, w/w) to prepare a 1000 ppm stock solution.

The following 3 alcoholic solutions are prepared:
A: 1 ppm N-vanillyl urea as obtained in example 1

5% (w/w) ethanol

B: 10 ppm N-vanillyl urea as obtained in example 1

5% (w/w) ethanol

C: 100 ppm N-vanillyl urea as obtained in example 1

5% (w/w) ethanol

All solutions were tasted by a trained flavourist panel and compared to a 5% (w/w) alcoholic solution (the reference). Solution A exhibited a more alcohol-like bite than the reference, and solution B and C exhibited stronger hot, sharp and pungent, ethanol-like taste compared to the reference solution.

### Example 3

2 solutions were prepared containing respectively:

A: 0.6% sodium chloride

0.03% mono sodium glutamate

B: 0.6% sodium chloride

0.03% mono sodium glutamate

10 ppm N-vanillyl urea as described in example 1

Both solutions were tasted by a trained flavourist panel, which described the solutions as follows:

A: salty, umami
B: more salty, umami, warm, bite, preferred to A

### Example 4

1 ppm N-vanillyl urea as described in example 1 was added to a 10 ppm menthol solution and compared to the base. Both solutions were tasted by a trained flavourist panel, which described the solutions as follows:

Base (10 ppm menthol solution): cooling, slightly burning, bitter aftertaste
Base+1 ppm N-vanillyl urea: powerful and full cooling sensation, preferred to the base

### Example 5

### Synthesis of N-octyl-N′-vanillyl urea (method A)

To a suspension containing 4.5 g vanillyl amine HCl and 3 g triethyl amine in 20 ml of DMF a solution of N-octyl isocyanate in 10 ml of DMF was added dropwise at a temperature of between 20 and 35° C. without external cooling. The mixture was stirred for 7 hrs. The white precipitate (triethylamine HCl) was filtered and 40 ml of a 5% aqueous solution of hydrochloric acid was added to the filtrate. The mixture was stirred for 10 minutes and the insoluble crystals were filtered, washed with water and recrystallized from methanol/water. The white crystals (4.1 g) were dried in a vacuum oven at 70° C. for 1 hour and sampled for NMR and TLC analysis. Yield was 100%. Purity was about 95%.

### Example 6

### Synthesis of N-octyl-N′-vanillyl urea (method B)

A suspension of 4.5 g of vanillyl amine HCl in 30 ml DMF was heated to 50° C. A solution of 6.5 g of N-octyl-1H-imidazole-1-carboxamide (6.5) in 15 ml of DMF was added at 50° C. After 10 minutes a clear solution was obtained. 4 g of triethyl amine was added and stirring was continued at 60° C. overnight. The solvent was removed using a rotary evaporator. 40 ml of a 5% solution of aqueous hydrochloric acid was added to the residue and the mixture was stirred for 10 minutes. The insoluble crystals were filtered and recrystallized from alcohol/water. The formed crystals were filtered, washed with water and dried in a vacuum oven at 50° C. for 2 hours. The dried cream crystals (3.9 g) were sampled for NMR and TLC analysis. Yield was 96%. Purity was about 95%.

### Example 7

A solution of 50 ppm N-vanillyl urea (as obtained in example 1) in water had a slightly tingling taste and a weak vanillin-like flavour sensation was experienced

A solution of 25 ppm N-vanillyl thiourea in water had a tingling, burning and slightly bitter taste and a weak vanillin-like flavour sensation was experienced
A solution of 1 ppm N-vanillyl N′-octyl urea (as obtained in example 5) in water had a strong tingling and burning taste.

### Example 8

Three samples of fondant were prepared by mixing 65% Fondacreme (ex Belgosuc NV Belgium) with 35% sugar syrup (67° Brix). 2500 Ppm menthol was added as a 50% solution in propylene glycol.

To a first sample (sample A), 0.1 ppm N-vanillyl-N′-octyl urea was added
To a second sample (sample B), 0.2 ppm N-vanillyl-N′-octyl thiourea was added.
Samples A, B and the reference sample were tasted by a professional panel.
Sample A gave a more intense and long-lasting cooling effect compared to the reference sample. The cooling was perceived more through the whole oral cavity. Sample B gave the same effects but slightly weaker.

### Example 9

Three solutions of 0.6% NaCl and 0.03% MSG were prepared.

To a first solution (sample A), 0.1 ppm N-vanillyl-N′-octyl urea was added
To a second solution (sample B) 0.2 ppm N-vanillyl-N′-octyl thiourea was added.

Samples A and B and the reference sample were tasted by a professional panel.

Sample A was judged to be more salty compared to the reference sample. Moreover the salt impression came faster than in the reference. Sample B gave the same effects but slightly weaker.

### Example 10

Three solutions of 0.6% NaCl and 0.03% MSG were prepared.

To a first solution (sample A), 5 ppm N-vanillyl-N′-octyl urea was added
To a second solution (sample B), 10 ppm N-vanillyl-N′-octyl thiourea was added.

Samples A and B and the reference sample were tasted by a professional panel.

Sample A was judged to be more salty and had a ‘clean’ and long lasting (up to 10 minutes) hotness compared to the reference sample. Moreover the salt impression came faster than in the reference sample. Sample B gave the same effects but slightly weaker.

### Example 11

Three solutions of 0.6% NaCl and 0.03% MSG and 4 ppm pepper oleoresin (ex Warner Jenkinson, St Louis, USA) were prepared.

To a first solution (sample A), 1 ppm N-vanillyl-N′-octyl urea was added
To a second solution (sample B), 2 ppm N-vanillyl-N′-octyl thiourea was added.

Samples A and B and the reference sample were tasted by a professional panel.

Sample A is clearly more hot than the reference sample and the overall impression is much stronger. Sample B gave the same effects but slightly weaker.

### Example 12

Three solutions of 3% alcohol in water were prepared.

To a first solution (sample A), 0.1 ppm N-vanillyl-N′-octyl urea was added
To a second solution (sample B), 0.5 ppm N-vanillyl-N′-octyl thiourea was added.
Samples A and B and the reference sample were tasted by a professional panel and compared with ethanol water mixtures. Sample A and B tasted like 5-6% ethanol water mixture.

### Example 13

97 g of a toothpaste base was prepared as follows: 13.8 ml demineralised water, 0.1 g trisodium phosphate (12H₂O) and 0.8 g sodium monofluorophosphate were weighed and mixed until clear. 50.0 g of sorbitol was added and the blend was mixed again. The obtained mixture was placed in a Fryma pot. A poly bag was placed in a suitable container and 8.0 g of precipitated silica AC30, 9.0 g of precipitated silica TC15, 0.8 g of sodium carboxymethylcellulose (SCMC 9M31XF) and 1.0 g of a colorant (Tiona (1700)) were weighed and placed in the bag in the order listed. The top of the bag was secured with a tag and the contents were thoroughly mixed to distribute the gum throughout the mixture.

This mixture was added to the Fryma pot. Then 7.0 ml of demineralised water, 1.5 g of sodium lauryl sulphate (Empicol LXV100C) and 5.0 g of PEG 1500 were placed in a beaker and heated to 45° C. and mixed with a Turrax to disperse the ingredients. The dispersion was placed on a magnetic stirrer until clear (while covered with cling film) and was subsequently added to the Fryma pot.

To this base toothpaste 0.8 g of a 25% saccharin soln was added. Part of the base toothpaste was then intensively mixed with N-vanillyl-N′-octyl urea (as obtained in Example 4) to obtain a 0.1 ppm concentration of N-vanillyl-N′-octyl urea (sample A). Another part was mixed with WS-3 (a commercially available coolant composition from Wilkinson-Sword) to obtain a 10 ppm concentration of WS-3 (Sample B). Sample A and B were tasted by a professional panel and compared with the base toothpaste.

Sample A gave a more aggressive cooling and more cooling volume in the oral cavity than the base. The cooling effect was extremely long-lasting but not irritating. Sample A had a more natural cooling boosting and some tingling effect. Sample B was in between sample A and the base in cooling strength and gave a more artificial cooling boosting.

1. Flavouring composition comprising at least 0.1 wt % of one or more flavouring substances and at least 0.1 wt % of one or more flavour modulating substances selected from the group represented by formula (I), edible salts thereof and edible esters thereof: 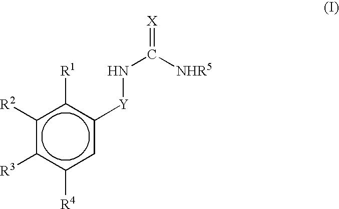
wherein R¹, R², R³ and R⁴ independently represent hydrogen, hydroxyl or a C₁-C₃ alkoxy group,
R⁵ represents hydrogen, phenyl, linear C₁-C₁₂ alkyl or C₇-C₁₂ aralkyl, each optionally substituted with one or more substituents selected from C₁-C₆ alkyl and hydroxyl; or
a moiety represented by the following formula (II) 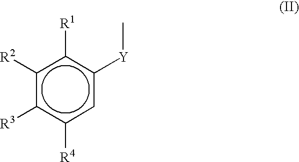
Y represents —CH₂— or —C(O)—; and
X represents ═NH, ═O or ═S;
with the proviso that at least one of R¹, R², R³ and R⁴ represents hydrogen.

2. Flavouring composition according to claim 1, wherein two of R¹, R², R³ and R⁴ represent hydrogen.

3. Flavouring composition according to claim 1 or 2, wherein R⁵ represents hydrogen, 2-hydroxyethyl or a moiety represented by formula (II).

4. Flavouring composition according to any one of the preceding claims, wherein R⁵ represents linear C₃-C₁₂ alkyl.

5. Flavouring composition according to any one of the preceding claims wherein R⁵ represents phenyl or C₆-C₁₀ aralkyl.

6. Flavouring composition according to any one of the preceding claims, wherein R¹ and R² independently represent hydroxyl, methoxy or ethoxy.

7. Flavouring composition according to any one of claims 1-5 wherein R² and R³ independently represent hydroxyl, methoxy or ethoxy.

8. Flavouring composition according to claim 1, wherein said flavour modulating substance is selected from the group of N-vanillyl urea, N-vanillyl thiourea, N-vanillyl guanidine, N-isovanillyl urea, N-(3-ethoxy-4-hydroxybenzyl) urea, N-(3,4 dimethoxybenzyl) urea, N,N′-divanillyl urea, N,N′-divanillyl thiourea, N-octyl-N′-vanillyl urea, N-octyl-N′-vanillyl thiourea, N-hexyl-N′-vanillyl urea, N-hexyl-N′-vanillyl thiourea, N-decyl-N′-vanillyl urea, N-decyl-N′-vanillyl thiourea, N-benzyl-N′-vanillyl urea, N-benzyl-N′-vanillyl thiourea, edible salts thereof and edible esters thereof.

9. Product selected from the group of foodstuffs, beverages, tobacco products, and oral care products, said product comprising at least 0.01 ppm of one or more of the flavour modulating substances defined in claims 1-8.

10. Product selected from foodstuffs and beverages comprising 0.01 ppm of one or more of the flavour modulating substances defined in any one of claims 1-8 and at least 0.5 wt % of alcohol.

11. Method of improving the flavour of a product selected from the group of foodstuffs, beverages, tobacco products, and oral care products, preferably from the group of alcoholic foodstuffs and alcoholic beverages, comprising incorporating in said product a flavour modulating substance as defined in any one of claims 1-8.

12. Use of a flavour modulating substance as defined in any one of claims 1-8, edible salts thereof and/or edible esters thereof for boosting alcohol flavour of alcoholic foodstuffs and beverages.

13. Process of producing a flavour modulating substance comprising reacting a substance represented by the following formula (III) or a salt or ester thereof with a substance represented by the following formula (IV) or a salt thereof: 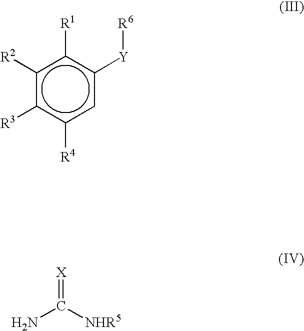
wherein:
R¹, R², R³, R⁴, R⁵ X and Y have the same meaning as defined in any one of claims 1-7, and wherein R⁶ represents ═O or —NH₂ if Y represents —CH₂— or R⁶ represents —OH or —H if Y represents —C(O)—.
